(19) United States
(12) Patent Application Publication
(10) Pub. No.: US 2026/0251535 A1
(43) Pub. Date: Aug. 27, 2026

(54) SAMPLE CAPSULE, SAMPLING DEVICE AND SAMPLING METHOD

(71) Applicant: Bürkle GmbH, Bad Bellingen (DE)

(72) Inventor: Ralf Breitmoser, Staufen (DE)

(21) Appl. No.: 19/545,643

(22) Filed: Feb. 20, 2026

(30) Foreign Application Priority Data
Feb. 25, 2025 (DE) 10 2025 107 017.2

(51) Int. Cl. G01N 1/10

(52) U.S. Cl. CPC G01N 1/10

(57) ABSTRACT

A sample capsule for a sampling device, wherein the sample capsule is configured to receive a sample, the sample capsule having a sample capsule body with a sample receiving chamber for receiving the sample. The sample has a receiving space chamber that extends in a longitudinal direction of the sample capsule and a width direction of the sample capsule, and a lid, which is connected to the sample capsule body in such a way that the lid can be moved in the width direction relative to the sample capsule body for opening and closing the sample receiving chamber. Furthermore, a sampling method of using a sampling device with such a sample capsule includes taking a sample by rotating elements of the device.

### TECHNICAL FIELD

The invention relates to a sample capsule for a sampling device, the sample capsule comprising a sample capsule body being configured to receive a sample, in particular a liquid, powdery or granular sample.

Furthermore, the invention relates to a sampling device for taking a sample, wherein the sampling device for taking a sample, the sampling device comprising an elongate sample capsule receiving element, which has a sample capsule recess for inserting a sample capsule body of such a sample capsule.

Moreover, the invention relates to a sampling method for taking a sample from a total sample volume using such a sampling device.

### BACKGROUND

Conventionally, a wide variety of sampling devices can be used to take liquid, powdery or fine-grained or granular or coarse-grained samples from a sample material or a total sample volume. Depending on the application, these differ in their design and dimensions.

The primary function of sampling is often to take a representative sample from the sample material or the total sample volume required for the analysis, for example to take a contamination-free sample. Subsequently, reliable statements can be made about the quality, characteristics or composition of the sample and thus conclusions can be drawn about the sample material, e.g. by means of an analysis in the laboratory.

Conventional sampling devices for taking a sample without contamination, for example, are designed in such a way that, at least when the sampling device is used as intended, non-contact sampling, i.e. without the person taking the sample coming into contact with the sample, is guaranteed in order to avoid contamination of the sample. Non-contact sampling is also particularly important if the sample contains material that is potentially hazardous or harmful to humans or the environment. In this context, it must be possible to take the sample in such a way that no material is spilled or leaks out.

In this context, sampling device in the form of so-called sampling spears are known from the prior art. This is, for example, a rod-shaped sampling device with an outer shell (outer tube) and a sampling rod (inner tube), wherein the sampling rod and the outer shell of the sampling device are arranged concentrically and can be rotated in relation to each other. The sampling rod comprises recesses or indentations being configured to receive the sample, wherein the outer shell has corresponding openings so that, when the sampling spear is inserted into the sample or total sample volume and sampling rod and outer shell are rotated in relation to each other, the sample can pass through the openings of the outer shell into the recesses of the sampling rod. The sampling rod is then rotated (again) so that the outer shell serves to close or seal the recesses of the sampling rod.

After the sample has been taken, it is removed from the sampling spear for analysis, for example. If the analysis does not take place on site, the sample is transferred for transportation, usually manually, into a sample container in which it is stored while the sample is being transported to the place of analysis. Transferring and transportation of the sample is often not easy to carry out, as it can be relevant that the sample is transferred and transported in such a way that the sample arrives at its destination undamaged and, in particular, that no sample material is lost or contaminated; however, the transferring process, for example, already carries the risk of contamination.

For example, a sampling device is known from EP 3 104 153 B1 comprising a sample capsule (sample insert) that can be removed from the sampling device and can be closed with a lid. The problem with this sampling device, however, is that the inserts can only be closed with caps after the outer tube has been removed from the inner tube and only then can they be removed from the inner tube; this complex handling increases the risk of contamination of the samples taken.

Therefore, the object of the invention can be seen in developing the conventional sample capsules or sample inserts, sampling devices and sampling methods in such a way that handling in connection with taking samples and/or transportation and/or cleaning and/or sample storage is facilitated or simplified.

### SUMMARY OF INVENTION

This object is solved by the features of the independent claims.

Advantageous embodiments and modifications of the invention are set out in the dependent claims.

The sample capsule according to the invention is configured for a sampling device and is preferably designed for insertion into a sample capsule receiving element of the sampling device, wherein the sample capsule is configured to receive a sample, in particular a liquid, powdery or granular sample. The sample capsule according to the invention comprises a sample capsule body with a sample receiving chamber for receiving the sample, wherein the sample receiving chamber extends in a longitudinal direction of the sample capsule and a width direction of the sample capsule. Furthermore, the sample capsule according to the invention comprises a lid being connected to the sample capsule body in such a way that the lid is movable or guided movable in the width direction relative to the sample capsule body for opening and/or closing the sample receiving chamber.

Based on this configuration of the sample capsule according to the invention, a mechanism can be implemented by means of which the sample receiving chamber of the sample capsule body can be opened and closed in an extremely easy-to-handle manner. For example, the sample receiving chamber can be opened and closed by the lid by rotating an elongated sample capsule receiving element connected to a handle (non-rotatable) in relation to a tubular element (outer tube) receiving the sample capsule receiving element, without having to remove the sample capsule body from the sampling device or disassemble the sampling device. This enables contamination-free sampling.

The sample capsule according to the invention can be advantageously further configured in such a way that the lid is connected to the sample capsule body by means of a guiding device, the guiding device being configured to guide the lid movable in the width direction relative to the sample capsule body, while movement of the lid in the longitudinal direction relative to the sample capsule body is prevented. Accordingly, the lid can be moved in the width direction of the sample capsule body by means of the guiding device, but not in its longitudinal direction. The guiding device is therefore, for example, a forced guide in the form of a linear guide, which allows the lid to move in the width direction but prevents it from moving in the longitudinal direction.

Furthermore, the sample capsule according to the invention can be configured in such a way that the guiding device configured to guide the lid in the width direction relative to the sample capsule body in a movable or pivotable manner on a path curve. In this context, the path curve preferably describes a circular path, at least in sections. Accordingly, the lid, seen in a top view of the sample capsule or the sample capsule body, is guided so that it can move in the width direction. Viewed in perspective, the lid is guided in the circumferential direction of the sample capsule body due to the pivoting movement.

Furthermore, the sample capsule according to the invention can be configured such that the lid has at least one projection on its inner side facing the sample receiving chamber and the sample capsule body has at least one recess facing the inner side of the lid, wherein the at least one projection is slidingly guided in the at least one recess in such a way that the lid is pivotably or swiveling or movable mounted in the width direction with respect to the sample capsule body.

Furthermore, the sample capsule according to the invention can be realized in such a way that the lid can be decoupled or detached from the sample capsule body by moving relative to the sample capsule body over a predetermined extent. In other words, the lid is disengaged from the sample capsule body and thus detached when the lid is moved beyond a predetermined extent relative to the sample capsule body.

The sampling device according to the invention is configured to take a sample, preferably a liquid, powdery or granular sample, wherein the sampling device comprises: an elongate sample capsule receiving element (inner tube), which has a sample capsule recess for inserting a sample capsule body (or an insert) of the sample capsule according to the invention, wherein the sample capsule body is immovably inserted into the sample capsule recess, wherein the sample capsule receiving element is arranged to guide the lid in sections at least in the width direction or circumferential direction when the lid is moved away relative to the sample capsule body over a predetermined extent in the width direction or circumferential direction. The lid is therefore preferably guided exclusively by the guiding device on the sample capsule body side when the sampling chamber is completely closed. If the lid is moved by a certain extent in the width direction, it is also guided at least in sections by the guiding device on the sample capsule receiving element side.

This results in the properties and advantages explained in connection with the sample capsule according to the invention in the same or similar way, which is why reference is made to the above explanations in connection with the sample capsule according to the invention in order to avoid repetition.

The same applies mutatis mutandis to the following preferred embodiments of the sampling device according to the invention, which is why reference is also made in this respect to the above explanations in connection with the sample capsule according to the invention.

The sampling device according to the invention may have a modular design and can also be realized in different lengths. The sample capsule body and the lid can optionally be made of high-density polyethylene (HDPE) but can also be made of PTFE (polytetrafluoroethylene) or other materials.

For example, the sampling device can be suitable for sampling pharmaceutical powder or other powder, wherein the volume to be sampled can be 0.1 - 2.5ml or 0.1 -3 ml. Of course, the sample capsule receiving element may also have a plurality of sample capsule recesses arranged offset in the longitudinal direction and/or in the circumferential direction, so that a plurality of sample capsule bodies can be used. Accordingly, in this case the tubular element (outer tube) is formed with corresponding openings.

The sampling according to the invention can be advantageously formed such that the sampling device further comprises a hollow cylindrical tubular element (outer tube) with an opening corresponding at least with the lid, wherein the tubular element receives the sample capsule receiving element in its cylindrical cavity and the lid and the opening are aligned in such a way that when the sample capsule receiving element is rotated within the tubular element, the sample capsule body is moved relative to the lid in order to release and/or close the sample receiving chamber of the sample capsule body via the opening. The sample receiving chamber is thus moved by means of the rotation of the sample capsule body to a section of the opening at which the sample receiving chamber is exposed or via which the sample receiving chamber can be filled with a sample via the opening.

Furthermore, the sampling device according to the invention can be designed such that the opening has a first opening portion, which corresponds to the lid, and a second opening portion, which is adjacent thereto in the width direction and corresponds at least partially to the sample receiving chamber of the sample capsule body. As already mentioned, the sample receiving chamber is moved from the first opening portion, where the sample receiving closed is closed by the lid, to the second opening portion, where the sample receiving chamber is exposed or can be filled with a sample via the second opening portion, based on the rotation of the sample capsule body. The lid is fitted into the first opening portion and is therefore immovable or fixed.

Moreover, the sampling device according to the invention can be realized in such a way that the sample capsule receiving element and the tubular element can be moved relative to each other such that in a first position the lid closes the sample receiving chamber of the sample capsule body, while preferably a closure portion of the sample capsule receiving element closes the second opening portion, and/or in a second position the sample receiving chamber of the sample capsule body is opened via the second opening portion, while the lid is held in the first opening portion and closes it, and/or in a third position the lid is disengaged from the sample capsule receiving element, so that the sample capsule body together with the lid can be removed from the sampling device via the first opening portion.

The sampling method according to the invention is provided for taking a sample, in particular a liquid, powdery or granular sample, from a total sample volume using the sampling device according to the invention, the method comprising the following steps:

inserting the sampling device into the total sample volume with the sample receiving chamber of the sample capsule body inserted in the sample capsule receiving element closed by the lid;

relative rotation of the sample capsule receiving element with respect to the tubular element such that the sample receiving chamber of the sample capsule body is opened via the second opening portion, while the lid is held in the first opening portion and closes it,

taking the sample;

relative rotation of the sample capsule receiving element with respect to the tubular element in such a way that the sample receiving chamber is closed again by the lid in the first opening portion and removal of the sampling device from the total sample volume;

relative rotation of the sample capsule receiving element with respect to the tubular element such that the lid is disengaged from the sample capsule receiving element and removal of the sample capsule body together with the lid via the first opening portion from the sampling device.

This results in the properties and advantages explained in connection with the sample capsule according to the invention in the same or similar way, which is why reference is made to the above explanations in connection with the sample capsule according to the invention in order to avoid repetition.

### BRIEF DESCRIPTION OF THE DRAWINGS

A preferred embodiment of the invention is explained below by way of example with reference to the figures.

It shows:

FIG. 1 shows a schematic representation of a sample capsule according to the invention in a perspective view;

FIG. 2 shows a schematic representation of a sampling device according to the invention with the sample capsule according to the invention of FIG. 1 inserted in a sectional view;

FIGS. 3a-c show schematic representations of the sampling device according to the invention in different positions in respective perspective views;

FIG. 4 shows a schematic representation of the sampling device according to the invention as an example during the transition from one position to another.

### DETAILED DESCRIPTION

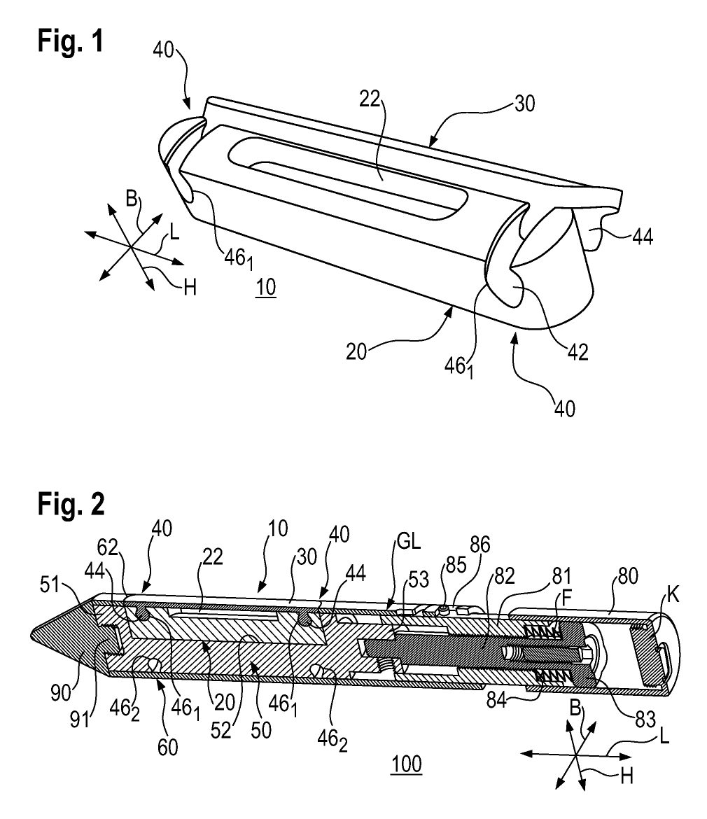

FIG. 1 shows a schematic representation of a sample capsule 10 according to the invention, also referred to as a so-called insert or sample insert, in a perspective view, which can be inserted into a sampling device 100 according to the invention, in particular into a sample capsule receiving element 50 of the sampling device 100, which is described in more detail below.

The sample capsule 10 is configured to receive a sample such as a liquid, powdery or granular sample. For this purpose, the sample capsule 10 comprises a sample capsule body 20, also referred to as a sample insert body, or sample insert for short, which comprises a sample receiving chamber 22 for receiving the sample. The sample capsule body 20 has almost the shape of a cuboid, wherein the end sections of this cuboid pointing in the longitudinal direction L are rounded, as can be seen in FIG. 1. Furthermore, the upper side of the sample capsule body 20 is also curved in a certain radius in order to be flush with a tubular element 60 of the sampling device 100 when used in the sampling device 100 together with a lid 30, which is described below, and to be able to pivot or swivel the lid 30.

As can be seen in FIG. 1, the sample receiving chamber 22 is formed in the form of an elongate groove in the sample capsule body 20, wherein the sample receiving chamber 22 in the form of the elongate groove extends in a longitudinal direction L of the sample capsule 10 (or the sample capsule body 20) and a width direction B of the sample capsule 10. In addition, the groove extends in a height direction H of the sample capsule 10 with a specific groove depth. This determines the maximum volume of a sample to be taken in the sample receiving chamber 22.

Furthermore, the sample capsule 10 has the aforementioned lid 30, which is connected to the sample capsule body 20 in such a way that the lid 30 can be moved in the width direction B relative to the sample capsule body 20 to open and close the sample receiving chamber 22. In particular, the lid 30 is connected to the sample capsule body 20 by means of a guiding device 40, which is arranged to guide the lid 30 movably in the width direction B relative to the sample capsule body 20, while movement of the lid 30 in the longitudinal direction L relative to the sample capsule body 20 is prevented. The lid 30 therefore has one degree of freedom in the width direction B, while the lid 30 is fixed or immovable in the longitudinal direction L.

On the one hand, the guiding device 40 is formed by projections 44 on the inside of the lid 30 facing the sample receiving chamber 22, which protrude at each end of the lid 30 in relation to the longitudinal direction L on its inside and extend in the lateral direction B.

On the other hand, the guiding device 40 (on the sample capsule body side) is formed by recesses 46₁ in the sample capsule body 20, facing or open towards the inside of the lid 30, which are arranged corresponding to the respective projections 44 in the longitudinal direction L of the sample capsule body 20 at its end portions and extend in the width direction B.

The respective projections 44 engage in the respective recesses 46₁ and are slidingly guided, so that the lid 30 is pivotably or swiveling mounted with respect to the sample capsule body 20 in the width direction B.

The pivoting or swiveling capability of the lid 30 or the rotational movement capability of the lid 30 results in particular from the fact that the recesses 46₁ of the guiding device 40 are formed in the width direction B in such a way that they guide the lid 30 in the width direction B relative to the sample capsule body 20 on a path curve 42. Preferably, the path curve 42 describes, at least in sections, a circular path or an annular segment-shaped curve with a specific radius. In a top view (looking in the direction of the height axis H) of the sample capsule body 20, the lid is thus movably guided in the width direction B relative to the sample capsule body 20. Viewed spatially or in perspective, the lid 30 is guided to move in the circumferential direction due to the circular path curve 42. For this reason, an upper side of the sample capsule body 20 is also curved outwards in a radius and an inner side of the lid 30 is curved correspondingly with the same radius to the upper side of the sample capsule body 20. In addition, the upper side of the lid 30 is also curved in the same radius in order to be flush with the tubular element 60 (outer tube) of the sampling device, which is explained in more detail below.

Furthermore, it can be seen from FIG. 1 that the lid 30 can be decoupled or released from the sample capsule body 20 by relative movement to the sample capsule body 20 over a predetermined extent, i.e. the respective projections 44 are disengaged from the respective recesses 46₁.

As already mentioned above, the sample capsule 10, in particular the sample capsule body 20 together with the lid 30, is used for insertion into a sampling device 100 according to the invention, which is shown, for example, in FIG. 2.

In particular, FIG. 2 shows a schematic representation of the sampling device 100 according to the invention with inserted sample capsule 10 according to the invention, i.e. with inserted sample capsule body 20 together with the lid 30, of FIG. 1 in a sectional view.

As can be seen from FIG. 2, the sampling device 100 comprises an elongate sample capsule receiving element 50 which has a sample capsule recess or sample capsule receiving chamber or an insert receiving chamber 52 for inserting the sample capsule body 20 of the sample capsule 10 described above. The sample capsule body 20 is inserted into the sample capsule recess 52 with a precise fit, i.e. immovably in the longitudinal direction L and width direction B, i.e. fixed in these directions, for example by positive locking, but can be removed in the height direction H under certain conditions, which will be explained in more detail below.

The elongate sample capsule receiving element 50 is largely cylindrical, in particular in the form of an inner tube, and is arranged to guide the lid 30 in sections at least in the width direction B or circumferential direction when the lid 30 is moved away relative to the sample capsule body 20 over a predetermined extent in the width direction or circumferential direction.

In detail, the elongate sample capsule receiving element 50 in the form of the inner tube has two circumferential annular recesses 46₂ which, when the sample capsule body 20 is inserted, form a continuation of the two recesses 46₁ in the circumferential direction and are therefore aligned with the recesses 46₁. The circumferential recesses 46₂ of the sample capsule receiving element 50 and the recesses 46₁ thus form two axially spaced and circumferential circular rings.

When the sample capsule body 20 is inserted, the lid 30 can thus be moved in the circumferential direction over the entire circumference of the sample capsule receiving element 50.

However, it should be noted that the sampling device 100 does not have to be designed with completely rotating circular rings, but that appropriately dimensioned circular ring segments may be sufficient.

Furthermore, the sampling device 100 comprises a hollow cylindrical tubular element 60 (an outer tube acting as an outer casing) with an opening 62 corresponding in sections to the lid 30.

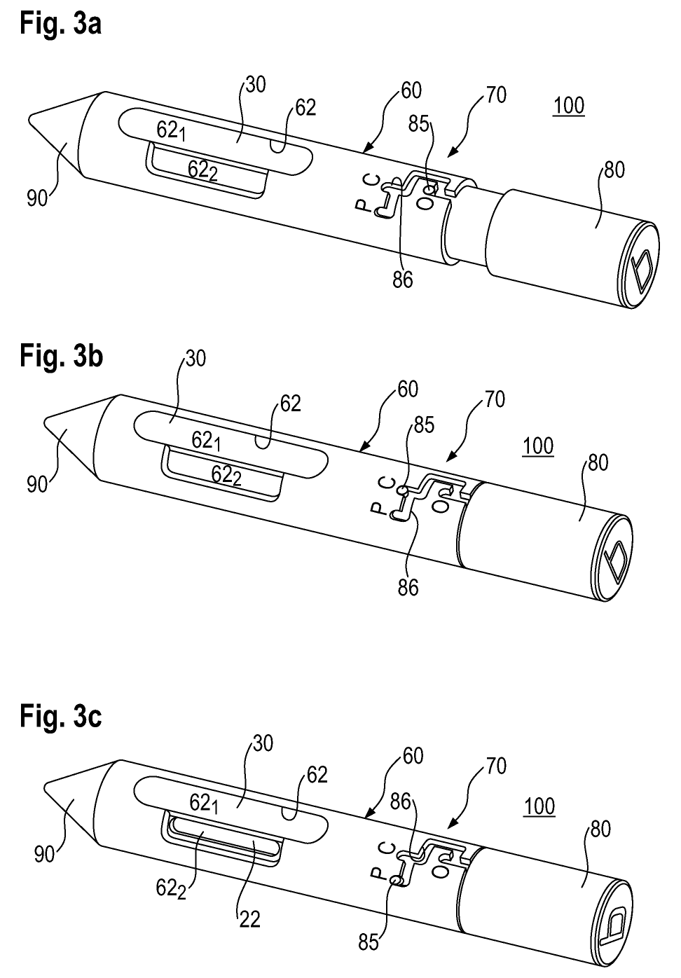

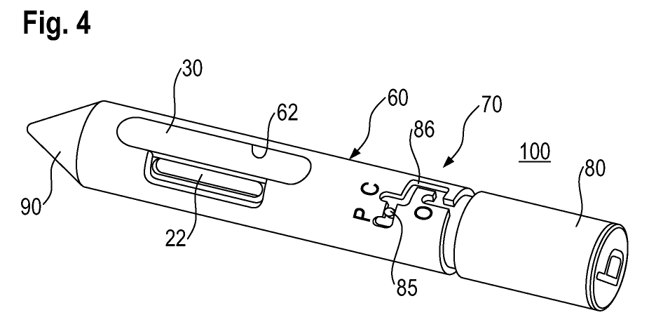

In particular, the opening 62 comprises a first opening portion 62₁which corresponds to the lid 30, i.e. the edge of the opening and the edge of the lid adjoin each other in sections and are therefore of the same fit, and further comprises a second opening portion 62₂which adjoins it in the width direction B and corresponds at least partially to the sample receiving chamber 22 of the sample capsule body 20 (in particular recognizable in FIGS. 3 and 4). The first opening portion 62₁ corresponds to the lid 30 in such a way that the lid is fixed in the longitudinal direction L and in the width direction B, i.e. has no degree of freedom in these directions. This means that the lid 30 can be inserted precisely into the first opening portion 62₁.

The tubular element 60 receives the sample capsule receiving element 50 in its cylindrical cavity and the lid 30 and the opening 62 or the first opening portion 62₁ are aligned in such a way that when the sample capsule receiving element 50 is rotated within the tubular element 60, the sample capsule body 20 is moved or rotated relative to the lid 30 in order to release the sample receiving chamber 22 of the sample capsule body 20 via the opening, in particular to release it via the second opening portion 62₂ , or to close it.

In other words, when the sample capsule receiving element 50 is rotated, the lid 30 is held by the shaping of the first opening portion 62₁ by means of positive locking, while the sample capsule receiving element 50 aligns together with the sample capsule body 20 so that the sample receiving chamber 22 is aligned under the second opening portion 62₂ or is exposed by the second opening portion 62₂ to be filled with a sample. In this state, the lid 30 is not only guided over the sample capsule body 20, but also over the sample capsule receiving element 50 or in engagement with it. In this state, the lid 30 is thus guided by the sample capsule body side and the sample capsule receiving element side guiding device 40. Furthermore, the sampling device 100 comprises a sampling tip 90, which in this embodiment example is arranged or attached to an end portion 61 of the hollow cylindrical tube element (outer tube) 60 (left side of the sampling device in FIG. 2), in that the sampling tip 90 is screwed to an end portion 51 of the sample capsule receiving element (inner tube) 50. The sampling tip 90 allows the sampling device 100 to taper outwards in the longitudinal direction L, while the sampling tip 90 has a threaded pin or bolt 91 on the inside for rotatable mounting of the sample capsule receiving element 50. In particular, the bolt 91 is screwed to an internal thread formed in the end portion 51. The sampling tip 90 forms a positive fit with the tubular element (outer tube) 60 or rests against its end portion 61 or is in abutment and holds the sample capsule receiving element 50 rotatably via the bolt 91 screwed to the sample capsule receiving element 50.

Furthermore, the sampling device 100 comprises a handle 80, which is non-rotatably connected to the sample capsule receiving element 50. Accordingly, a rotation of the handle 80 is converted or translated into a rotation of the sample capsule receiving element 50. However, the handle 80 is movable relative to the sample capsule receiving element 50 in the longitudinal direction L via a mechanism such as a locking mechanism.

The specific implementation of the mechanism is described in more detail below:

The handle 80 is sleeve-like and optionally formed with an end cap K (right end of the sampling device 100 in FIG. 2). A sleeve-like transmission element 81 is rigidly connected to the handle 80, in that the transmission element 81 is partially received in the sleeve-like handle 80 or partially inserted in a non-positive manner. The transmission element 81 therefore rotates with the handle 80 when it is rotated.

Furthermore, the transmission element 81 and the handle 80 are guided so as to be movable relative to the sample capsule receiving element 50 in the longitudinal direction L, i.e. the sample capsule receiving element 50 supports the transmission element 81 so as to be movable relative to it in the longitudinal direction L by means of a sliding bearing GL. This sliding bearing GL is realized by the fact that the transmission element 81 on the side of the sample capsule receiving element 50 has the form of a hollow cylinder, which is slidingly mounted on a corresponding shaft portion 53 of the sample capsule receiving element 50.

The transmission element 81 also accommodates a bolt element (guide rod) 82, which is rigidly connected to the sample capsule receiving element 50, for example by a mechanical fastening or an interference fit.

The bolt element 82 and the transmission element 81 are coupled in a rotationally fixed manner, but are movable relative to each other in the longitudinal direction L. A spring F, shown only schematically, pretensions the transmission element 81 in the direction of the sample capsule receiving element 50, for example by the spring F being supported on a step/recess 83 of the bolt element 82 and pressing against a step/recess 84 of the transmission element 81, as can be seen in particular in FIG. 2.

The non-rotatable connection between the bolt element 82 and transmission element 81 is achieved, for example, by the step/recess 83 being held positively in the sleeve-like handle 80 in the circumferential direction, but not in the longitudinal direction L. For example, the handle 80 may not be circular on the inside but may have additional notches on the inside into which the protrusions of the otherwise circular step/recess 83 engage. Accordingly, the step/recess 83 and thus the bolt element 82 can be moved in the longitudinal direction L relative to the handle 80 but cannot be rotated relative to the handle 80.

By means of this arrangement or mechanism, the handle 80 can be moved away relative to the sample capsule receiving element 50 in the longitudinal direction L when the sampling tip 90 is bolted to the sample capsule receiving element 50, thereby compressing the spring F, as the handle 80 together with the transmission element 81 moves relative to the bolt element 82 and the sample capsule receiving element 50 in the longitudinal direction L away from the sampling tip 90.

For easy assembly of the sampling device, the step/recess 83 can also be a separate element with respect to the bolt element 82; for example, it can be designed as a bolt head that is screwed to the bolt element 82, as illustrated in FIG. 2. This makes it very easy to set up the sampling device 100.

The different positions of the sample capsule receiving element 50 in relation to the tubular element 60 are explained in more detail below.

FIGS. 3a-c show schematic representations of the sampling device 100 according to the invention in different positions in respective perspective views. As can be seen from FIGS. 3a-c, the sample capsule receiving element 50 can be moved into three different positions ("P" for the sample removal position, "C" for the closed position and "O" for the sample capsule removal position) in relation to the tubular element 60 by means of a positive guide 70, which is described in more detail below.

Thus, the sample capsule receiving element 50 and the tubular element 60 can be moved relative to each other in such a way that in a first position corresponding to the marked position “C” the lid 30 closes the sample receiving chamber 22 of the sample capsule body 20. In particular, the sample receiving chamber 22 is closed by the lid 30 located in the first opening portion 62₁, while the second opening portion 62₂ is closed by a closing portion of the sample capsule receiving element 50 (FIG. 3b).

Furthermore, the sample capsule receiving element 50 and the tubular element 60 can be moved relative to each other in such a way that in a second position corresponding to the marked position “P”, the sample receiving chamber 22 of the sample capsule body 20 is released or exposed via the second opening portion 62₂, while the lid 30 is held in the first opening portion 62₁ due to the positive fit and closes it (FIG. 3c).

In addition, the sample capsule receiving element 50 and the tubular element 60 can be moved relative to each other in such a way that in a third position corresponding to the marked position “O” the lid 30 is disengaged from the sample capsule receiving element 50, so that the sample capsule body 20 together with the lid 30 can be removed from the sampling device 100 via the first opening portion 62₁ (FIG. 3a).

As already mentioned, the movement between the first, second and third positions is predetermined by means of a positive guide 70, for example as a locking mechanism. For example, the transmission element 81 may have a control projection 85 which is movable within a control path 86 predetermined in the tubular element 60 in order to move the sample capsule receiving element 50 and the tubular element 60 relative to each other so that the first, second and third positions can be reached.

Accordingly, the operation of the sampling device 100 or the sampling is carried out according to the following sampling method according to the invention:

Initially, the sampling device is in its third position (“O”), in which the sample capsule body 20 is inserted into the sample capsule recess 52 of the sample capsule receiving element 50 (FIG. 3a). In this state, the lid 30 is only in engagement with the sample capsule body 20 via the guiding device 40 (on the sample capsule body side).

The sampling device 100 is then moved by moving the sample capsule receiving element 50 relative to the tubular element 60 from the “O” position via the control path of the positive guide 70 (formed by a conventional control path 86 in the tubular element 60 and the projection 85 on the transmission element 81) to the first position corresponding to the marked position “C”, so that the lid 30 closes the sample receiving chamber 22 of the sample capsule body 20 and at the same time the sample capsule receiving element 50 is brought into engagement with the lid, so that removal of the sample capsule body 20 together with the lid 30 is blocked (FIG. 3b). Accordingly, the sampling device 100 can be introduced into the total sample volume.

Then, starting from the first position corresponding to the marked position “C”, the second position corresponding to the marked position “P” is brought about by relative rotation of the sample capsule receiving element 50 with respect to the tubular element 60, as illustrated by the transition in FIG. 4, so that the sample receiving chamber 22 of the sample capsule body 20 is opened via the second opening portion 62 , while the lid 30 is held in the first opening portion 62₁ and closes it. The sample can therefore be taken. The lid 30 is also held in place by the guiding device 40 on the sample capsule receiving element side.

Subsequently, the sampling device 100 can be moved back into the first position by corresponding relative rotation of the sample capsule receiving element 50 with respect to the tubular element 60, so that the sample receiving chamber 22 is closed again by the lid 30 in the first opening portion 62₁. Accordingly, the sampling device 100 is then removed from the total sample volume.

Finally, by relatively rotating the sample capsule receiving element 50 with respect to the tubular element 60 to the third position, the lid 30 can be disengaged from the sample capsule receiving element 50, thereby enabling removal of the sample capsule body 20 together with the lid 30 from the sampling device 100 via the first opening portion 62₁. The sample capsule 20 can now be transported in a separate container.

After the sample has been taken and the sample capsule body 20 has been removed, the sampling device according to the invention can be disassembled, for example for cleaning, by loosening or unscrewing the sampling tip 90 from the sample capsule receiving element (inner tube) 50. Accordingly, the handle 80 of the third position (“O”) can be moved axially away from the hollow cylindrical tubular element 60 (outer tube) via the positive guide 70, so that the sample capsule receiving element 50 is pulled out of the tubular element 60 (outer tube). Cleaning is now possible without further ado.

The features of the invention disclosed in the above description, in the drawings and in the claims may be essential for the realization of the invention either individually or in any combination.

### Aspects of the Invention

According to a first aspect of the invention a sample capsule (10) for a sampling device (100) is configured to receive a sample, in particular a liquid, powdery or granular sample, and comprises

a sample capsule body (20) with a sample receiving chamber (22) for receiving the sample, wherein the sample receiving space chamber (22) extends in a longitudinal direction (L) of the sample capsule (10) and a width direction (B) of the sample capsule (10), and

a lid (30), which is connected to the sample capsule body (20) in such a way that the lid (30) can be moved in the width direction (B) relative to the sample capsule body (20) for opening and/or closing the sample receiving chamber (22).

According to a second aspect of the invention the sample capsule (10) according to the first aspect requires that the lid (30) is connected to the sample capsule body (20) by means of a guiding device (40),

wherein the guiding device (40) is configured to guide the lid (30) movable in the width direction (B) relative to the sample capsule body (20), while movement of the lid (30) in the longitudinal direction (L) relative to the sample capsule body (20) is prevented.

According to a third aspect of the invention the sample capsule (10) according to second aspect requires that the guiding device (40) is configured to guide the lid (30) in the width direction (B) relative to the sample capsule body (20) in a movable or pivotable manner on a path curve (42).

According to a fourth aspect of the invention the sample capsule (10) according to third aspect requires that the path curve (42) describes a circular path at least in sections.

According to a fifth aspect of the invention the sample capsule (10) according to the first, second, third or fourth aspect requires that the lid (30) has at least one projection (44) on its inner side facing the sample receiving chamber (22) and the sample capsule body (20) comprises at least one recess (46₁) facing the inner side of the lid (30), wherein the at least one projection (44) is slidingly guided in the at least one recess (46₁) in such a way that the lid (30) is pivotably mounted in the width direction (B) with respect to the sample capsule body (20).

According to a sixth aspect of the invention the sample capsule (10) according to the first, second, third, fourth or fifth aspect requires that the lid (30) can be decoupled or detached from the sample capsule body (20) by moving relative to the sample capsule body (20) over a predetermined extent.

According to a seventh aspect of the invention a sampling device (100) for taking a sample, preferably a liquid, powdery or granular sample, comprises

an elongate sample capsule receiving element (50), which has a sample capsule recess (52) for inserting a sample capsule body (20) of a sample capsule (10) according to any one of claims 1 to 5,

wherein the sample capsule body (20) is immovably inserted into the sample capsule recess (52),

wherein the sample capsule receiving element (50) is arranged to guide the lid (30) in sections at least in the width direction or circumferential direction when the lid (30) is moved away relative to the sample capsule body (20) over a predetermined extent in the width direction or circumferential direction.

According to an eighth aspect of the invention the sampling device (100) according to sixth aspect further comprises a hollow cylindrical tubular element (60) with an opening (62) corresponding at least with the lid (30),

wherein the tubular element (60) receives the sample capsule receiving element (50) in its cylindrical cavity and the lid (30) and the opening (62) are aligned in such a way that when the sample capsule receiving element (50) is rotated within the tubular element (60), the sample capsule body (20) is moved relative to the lid (30) in order to release and/or close the sample receiving chamber of the sample capsule body (20) via the opening.

According to a ninth aspect of the invention the sampling device (100) according to the sixth or seventh aspect requires that the opening (62) has a first opening portion (62₁), which corresponds to the lid (30), and a second opening portion (62₂), which is adjacent thereto in the width direction (B) and corresponds at least partially to the sample receiving chamber (22) of the sample capsule body (20).

According to a tenth aspect of the invention the sampling device (100) according to the sixth, seventh or eighth aspect requires that the sample capsule receiving element (50) and the tubular element (60) can be moved relative to each other such that in a first position the lid (30) closes the sample receiving chamber (22) of the sample capsule body (20) and/or in a second position the sample receiving chamber (22) of the sample capsule body (20) is opened via the second opening portion (62₂), while the lid (30) is held in the first opening portion (621) and closes it, and/or in a third position the lid (30) is disengaged from the sample capsule receiving element (50), so that the sample capsule body (20) together with the lid (30) can be removed from the sampling device (100) via the first opening portion (62₁).

According to an eleventh aspect of the invention a sampling method for taking a sample, in particular a liquid, powdery or granular sample, from a total sample volume using a sampling device (100) according to the sixth, seventh, eighth, ninth or tenth aspect comprises the following steps:

inserting the sampling device (100) into the total sample volume with the sample receiving chamber (22) of the sample capsule body (20) inserted in the sample capsule receiving element (50) closed by the lid (30);

relative rotation of the sample capsule receiving element (50) with respect to the tubular element (60) such that the sample receiving chamber (22) of the sample capsule body (20) is opened via the second opening portion (62₂), while the lid (30) is held in the first opening portion (62₁) and closes it,

taking the sample;

relative rotation of the sample capsule receiving element (50) with respect to the tubular element (60) in such a way that the sample receiving chamber (22) is closed again by the lid (30) in the first opening portion (62₁) and removal of the sampling device (100) from the total sample volume;

relative rotation of the sample capsule receiving element (50) with respect to the tubular element (60) such that the lid (30) is disengaged from the sample capsule receiving element (50) and removal of the sample capsule body (20) together with the lid (30) via the first opening portion (62₁) from the sampling device (100).

1. Sample capsule (10) for a sampling device (100), the sample capsule (10) being configured to receive a sample, the sample capsule (10) comprising
a sample capsule body (20) with a sample receiving chamber (22) for receiving the sample, wherein the sample receiving space chamber (22) extends in a longitudinal direction (L) of the sample capsule (10) and a width direction (B) of the sample capsule (10), and
a lid (30), which is connected to the sample capsule body (20) in such a way that the lid (30) can be moved in the width direction (B) relative to the sample capsule body (20) for opening and/or closing the sample receiving chamber (22).

2. Sample capsule (10) according to claim 1, wherein the lid (30) is connected to the sample capsule body (20) by means of a guiding device (40),
wherein the guiding device (40) is configured to guide the lid (30) movable in the width direction (B) relative to the sample capsule body (20), while movement of the lid (30) in the longitudinal direction (L) relative to the sample capsule body (20) is prevented.

3. Sample capsule (10) according to claim 2, wherein the guiding device (40) is configured to guide the lid (30) in the width direction (B) relative to the sample capsule body (20) in a movable or pivotable manner on a path curve (42).

4. Sample capsule (10) according to claim 3, wherein the path curve (42) describes a circular path at least in sections.

5. Sample capsule (10) according to claim 1, wherein the lid (30) has at least one projection (44) on its inner side facing the sample receiving chamber (22) and the sample capsule body (20) comprises at least one recess (46₁) facing the inner side of the lid (30), wherein the at least one projection (44) is slidingly guided in the at least one recess (46₁) in such a way that the lid (30) is pivotably mounted in the width direction (B) with respect to the sample capsule body (20).

6. The sample capsule (10) according to claim 1, wherein the lid (30) can be decoupled or detached from the sample capsule body (20) by moving relative to the sample capsule body (20) over a predetermined extent.

7. Sampling device (100) for taking a sample, the sampling device (100) comprising
an elongate sample capsule receiving element (50), which has a sample capsule recess (52) for inserting a sample capsule body (20) of a sample capsule (10) according to claim 1,
wherein the sample capsule body (20) is immovably inserted into the sample capsule recess (52),
wherein the sample capsule receiving element (50) is arranged to guide the lid (30) in sections at least in the width direction or circumferential direction when the lid (30) is moved away relative to the sample capsule body (20) over a predetermined extent in the width direction or circumferential direction.

8. Sampling device (100) according to claim 6, wherein the sampling device (100) further comprises a hollow cylindrical tubular element (60) with an opening (62) corresponding at least with the lid (30),
wherein the tubular element (60) receives the sample capsule receiving element (50) in its cylindrical cavity and the lid (30) and the opening (62) are aligned in such a way that when the sample capsule receiving element (50) is rotated within the tubular element (60), the sample capsule body (20) is moved relative to the lid (30) in order to release and/or close the sample receiving chamber of the sample capsule body (20) via the opening.

9. Sampling device (100) according to claim 6, wherein the opening (62) has a first opening portion (62₁), which corresponds to the lid (30), and a second opening portion (62₂), which is adjacent thereto in the width direction (B) and corresponds at least partially to the sample receiving chamber (22) of the sample capsule body (20).

10. Sampling device (100) according to claim 6, wherein the sample capsule receiving element (50) and the tubular element (60) can be moved relative to each other such that in a first position the lid (30) closes the sample receiving chamber (22) of the sample capsule body (20) and/or in a second position the sample receiving chamber (22) of the sample capsule body (20) is opened via the second opening portion (62₂), while the lid (30) is held in the first opening portion (621) and closes it, and/or in a third position the lid (30) is disengaged from the sample capsule receiving element (50), so that the sample capsule body (20) together with the lid (30) can be removed from the sampling device (100) via the first opening portion (62₁).

11. A sampling method for taking a sample from a total sample volume using a sampling device (100) according to claim 6, wherein the method comprises the following steps:
inserting the sampling device (100) into the total sample volume with the sample receiving chamber (22) of the sample capsule body (20) inserted in the sample capsule receiving element (50) closed by the lid (30);
relative rotation of the sample capsule receiving element (50) with respect to the tubular element (60) such that the sample receiving chamber (22) of the sample capsule body (20) is opened via the second opening portion (62₂), while the lid (30) is held in the first opening portion (62₁) and closes it,
taking the sample;
relative rotation of the sample capsule receiving element (50) with respect to the tubular element (60) in such a way that the sample receiving chamber (22) is closed again by the lid (30) in the first opening portion (62₁) and removal of the sampling device (100) from the total sample volume;
relative rotation of the sample capsule receiving element (50) with respect to the tubular element (60) such that the lid (30) is disengaged from the sample capsule receiving element (50) and removal of the sample capsule body (20) together with the lid (30) via the first opening portion (62₁) from the sampling device (100).
